(19) United States
(12) Patent Application Publication
(10) Pub. No.: US 2013/0070915 A1
(43) Pub. Date: Mar. 21, 2013

(54) System and Method for Selection of On Hold Media Content

(71) Applicants: Ricardo E Kanter, Pasadena, CA (US); Gerald Eugene Marshall, Kingston, WA (US); Patricia Mae Marshall, Kingston, WA (US)

(72) Inventors: Ricardo E Kanter, Pasadena, CA (US); Gerald Eugene Marshall, Kingston, WA (US); Patricia Mae Marshall, Kingston, WA (US)

(21) Appl. No.: 13/614,304

(22) Filed: Sep. 13, 2012

Related U.S. Application Data
(60) Provisional application No. 61/535,857, filed on Sep. 16, 2011.

(51) Int. Cl. H04M 11/00

(52) U.S. Cl. 379/93.01

(57) ABSTRACT

A system and method for an outside caller, when put on-hold, to select media content from options provided through a telephone switching system including Private Branch Exchanges (PBX's) using Voice over Internet Protocol (VOIP) are provided. The system is software or software/hardware configured to present to outside callers, while placed on hold, options for selecting available media. The software detects the selection made by the caller using a telephone keypad, voice recognition, or other input device and puts the selected media on the telephone line. The media content, audio or audio with video, can be updated with new content by manually loading into memory of the PBX Server or an appliance connected to the PBX Server. Content can also be downloaded from sources on the Internet and it can be downloaded or uploaded by media content providers to customers using the embodiment of this invention.

### RELATED APPLICATIONS

This application is a nonprovisional patent application claiming the benefit of U.S. Provisional Patent Application No. 61535857 (EFS No. 10971545) entitled “SYSTEM AND METHOD FOR SELECTION OF ON-HOLD MEDIA CONTENT” filed on Sep. 16, 2011 and nonprovisional patent No. 20050201531 A1 (Kanter, Ricardo, et al) entitled “SYSTEM AND METHOD FOR SELECTION OF ON-HOLD MEDIA CONTENT” published on Sep. 15, 2005.

### FIELD OF THE INVENTION

This invention relates generally to telephone system call receiving and origination and associated switching and, more specifically, to on-hold media content presented to outside callers.

### BACKGROUND OF THE INVENTION

Technology has both enabled and driven many changes in contemporary society. To name just one example, years ago merchants, service providers, and most other businesses tended to be small local companies. In this environment, business transactions frequently were conducted in person, on a face-to-face basis. However, the invention and the widespread proliferation of the telephone have significantly changed how business is done today. Items can be purchased, service calls can be arranged, and many other transactions can be consummated over the telephone. As a result of how the telephone has revolutionized the business world, as well as to take advantage of economies of scale, many smaller independent businesses have merged with or have been displaced by larger, centralized businesses. Although such larger businesses frequently have local agencies to deliver goods and services where desired, telephone calls that initiate the transactions may pass through one or more centralized call centers.

It is widely understood that such centralization naturally results in a potential bottleneck. Just as a flow of liquid may be slowed or stalled at a literal bottleneck where a relatively large body of liquid attempts to flow through a relatively narrow opening, a rush of numerous telephone calls simultaneously arriving at one large call center may be slowed or stalled. At one time, when a number of incoming telephone calls exceeded a number of lines at the call center, callers received a busy signal. To avoid losing potential customers upon encountering a busy signal, technology evolved to allow businesses to employ one or more receptionists to greet callers and place them “on hold” to await an opportunity to speak with representatives who could assist them.

Over time, an increasing number of businesses created “call centers” to centralize the handling of the countless calls being received, thereby resulting in a higher number of callers being placed on hold. To economize over the cost of human operators, automatic telephone answering and switching systems were devised to greet callers and inform them their calls had reached the call center. The telephone switching system would receive the calls and route the calls to an agent, or the system would automatically place the callers on hold and route their calls as agents became available. Such telephone switching systems are commonly termed private branch exchanges (PBXs) or “switches.”

With the passage of time, additional innovations were devised. The proliferation of the touch-tone phone allowed businesses to present callers with a menu of choices to identify why they were calling. Such systems allow a caller to self-direct his or her call to an appropriate agent when an appropriate agent became available to handle the previously identified requests.

In addition to improvements to economize call center operations, more innovations were developed to make callers' on-hold experiences less unpleasant. For example, instead of only hearing “dead air” while on hold, which often left callers wondering if they had been disconnected, pre-selected audio was played for the callers. Such audio originally included prerecorded music. Eventually, some on-hold audio was replaced or augmented with advertisements for the business's goods or services. Also, prerecorded music was replaced with a radio station broadcast being routed to the caller. Further innovations monitored how many calls were being processed relative to the number of available agents, and an average call length to inform callers how long they might have to wait for an agent.

With all these improvements, however, the sometimes lengthy and, unfortunately, sometimes seemingly interminable waiting remained. Even though callers might be provided with some audio content to help break the monotony of their waits and the callers might be warned how long they might have to wait, callers still often are stranded for potentially lengthy periods. During these potentially lengthy waits, all the callers have to divert them from their mounting frustration is the on-hold audio provided by the business. Unfortunately, if the audio is irritating or unpleasant to the caller, the caller may terminate the call, and may never call back. The caller might choose not to pursue the transaction, or might choose another provider. Whichever the caller might choose the caller's choice not to wait results in a lost opportunity for the business.

Thus, there currently is an unmet need in the technology for a call receiving or switching system able to make the time callers spend on hold more enjoyable or, at least, more tolerable, in order to maintain good customer relations and avoid losing business.

### SUMMARY OF THE INVENTION

Embodiments of the present invention enhance relationships with callers who contact users of the invention by allowing the callers to choose content offered to them while waiting on hold. As opposed to conventional systems where callers are presented with a pre-selected choice of content, whether music, information, advertising, or other content, embodiments of the present invention allow callers to select alternative content while waiting. Embodiments of the present invention evince respect and concern for callers' time by giving the callers a choice of content. Embodiments of the present invention also reduce callers' potential frustration in having to wait on hold by providing content that may help them more enjoyably to pass the time.

More particularly, one of the embodiments of the present invention provides a system and method allowing a caller to choose content from available options to be relayed to the caller while the caller is on hold. The telephone switching system is configured with this invention to exchange information with callers providing this capability.

In one embodiment of the present invention, when a caller is on hold, the system engages the telephone line on which the caller is on hold. The caller is provided with audio content options from which the caller can select by, for example, pressing a key on a telephone keypad. The system then engages audio content stored in a storage device within the system, or engages an external media source. The content from the on-board storage device or external media source is applied to the telephone line where it can be heard by a caller.

Users of embodiments of the present invention may desire to provide callers with a range of choices that include informational, promotional, and entertainment selections. For example, if an embodiment of the present invention is used by a financial institution, the institution may desire to provide callers on hold with information about different financial products offered by the financial institution, or various financial tips that callers may find informative and, thus, provide added value as perceived by the caller. Conventionally, many callers on hold are presented with promotional information about the institution they are calling. However, that information is presented as part of an unchanging ongoing loop that is presented to all callers whether they want to hear that information or not. This promotional information often is pre-recorded onto a looping tape device that endlessly repeats the prerecorded message.

Using embodiments of the present invention, the financial institution would not be limited to endlessly playing the same message for callers who are placed on hold, who may miss messages of interest or placed on hold and connected when the message of interest has mostly or completely played to its end. Instead, individual, updatable messages may be recorded and stored in system memory using any one of a number of digital recording and/or compression techniques, and can be regenerated using corresponding playback and/or decompression techniques. Thus, in the embodiment of the present invention a number of different prerecorded audio messages are made assessable to the caller on-hold. The audio selection message should be updated to reflect the available choices stored in recorded memory.

In addition to prerecorded audio messages, the institution using an embodiment of the present invention may wish to allow callers to listen to other audio content. For example, a radio station may be made available for callers to listen to while waiting, such as news or sports.

### BRIEF DESCRIPTION OF THE DRAWINGS

The preferred and alternative embodiments of the present invention are described in detail below with reference to the following drawings.

FIG. 1/2 is a drawing representing an overview of the embodiments of the present invention which employs current Internet Protocol (IP) and Voice over Internet Protocol (VoIP) technologies.

FIG. 2/2 is a flow chart of the software program using the embodiment of the present invention.

### DETAILED DESCRIPTION OF THE INVENTION

By way of overview, embodiments of the present invention provide a telephone switching system a method for allowing a caller to choose content to be received from a media source and relayed to the caller while the caller is on-hold. It includes a media selection generator and a media choice selector configured to receive a media choice made by the caller on hold and place on the telephone line the media choice made by the caller.

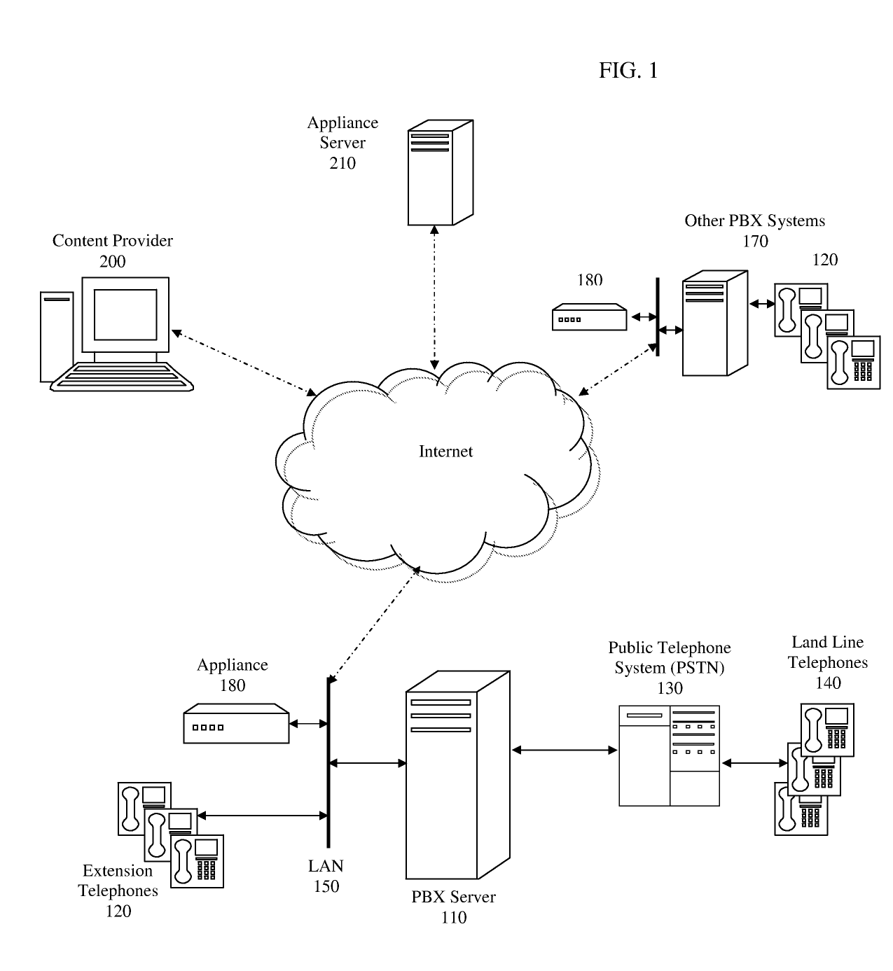

FIG. 1/2 is a drawing illustrating an overview of the embodiments of the present invention. Users of the embodiments of the present invention would utilize a computer [item 110], configured as a PBX server, which is connected to a Local Area Network (LAN) [115] which is also connected to the local extension telephones [item 120], an optional Appliance [item 135], the Public Telephone Switched Network (PTSN) [item 125] with associated Land Line Telephones

and connected to the Internet [item 140].

Callers using land line telephones [item 130] can connect through the PTSN [125] to the server [item 110] of the company that is being called. Internet Protocol (IP) telephone users [item 155] and companies using the Voice-Over-Internet-Protocol (VOIP) telephones [item 155] connect and communicate with each other and with PBX systems [110, 145] through the Internet [item 140].

Item [145] represents PBX systems in other companies that are similar to the system illustrated by items [110, 115, 120, 125, 130 and 135].

Item [160] represents audio and audio/visual Content Provider companies using the embodiments of this invention. Content and content updates can be uploaded by the content provider, via the Internet [140], to the PBX servers or to the Appliance Servers [165], if the optional Appliance [135] is used, using the embodiments of this invention. Statistics regarding caller's selections of content provided them can be downloaded by the content providers from the PBX Servers [110] or the Appliance Servers [165] and the information can be related to the companies employing the embodiments of the present invention.

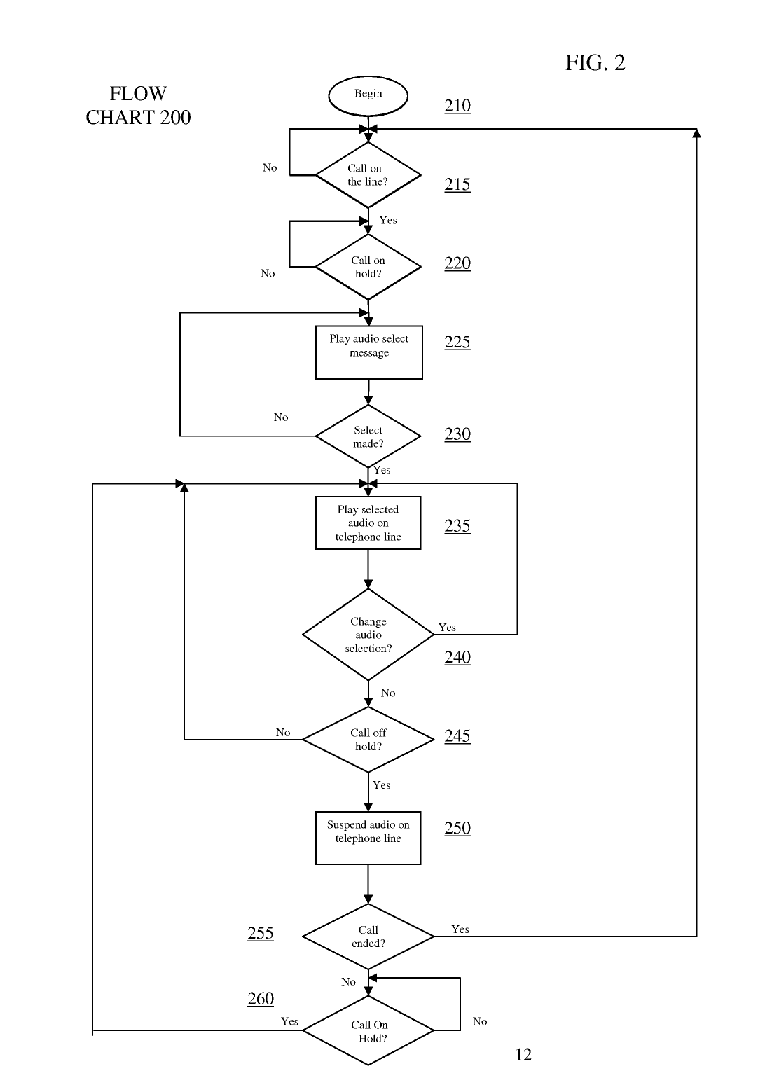

FIG. 2/2 is a flowchart of a preferred embodiment of the present invention. Flow diagram 200 is a flow diagram illustrating logical steps for detecting when callers are placed on-hold and providing options to those callers of available audio content. The diagram begins at step 210. At decision step 215, it is determined if there is a call on the line. If not, flow diagram 200 loops to decision step 215 until a call is detected on the line. On the other hand, once a call is detected on the line at decision step 215, at step 220 the telephone line is then monitored to determine if the call is placed on-hold. It will be appreciated that the telephone line could be monitored for on-hold status at all times, although if there is no call on the line the provision of selected audio content will not commence.

At decision step 220, it is determined if the call is on-hold and if not, flow diagram 200 loops to step 220 to continue monitoring for on-hold status. On the other hand, when it is determined that the call is on-hold at decision step 220, at step 225 the audio selection message is played for the caller. The audio selection message, as previously described, lists for the user what audio content choices are available, and what key the user should press or what word the user should say to select each.

At decision step 230, it is determined if the caller has made a selection of on-hold audio content. If not, in one embodiment of the present invention, flow diagram 200 loops to step 225 to commence replaying the audio selection message. On the other hand, at decision step 230 if it is determined that the selection has been made, flow diagram 200 proceeds to step 235 to connect the selected audio to the telephone line used by the caller.

Once the caller has been connected to the selected audio content at step 235, at decision step 240, it is determined if the caller has changed the audio selection. If the audio selection has been changed flow diagram 200 loops back to step 235 to connect the selected audio to the telephone line used by the caller. If, on the other hand, at step 240 if the audio content has not changed, at step 245 it is determined if the caller has been taken off-hold. If, at step 245 it is determined that the caller has not been taken off-hold, flow diagram 200 loops back to step 235. If, on the other hand, it is determined that the caller has been taken off-hold, at step 250 all messages are suspended on the telephone line used by the caller.

At decision step 255, it is determined if the call has ended. If it is determined that the call has ended, flow diagram 200 loops to decision step 215 to await another call being placed on the line. On the other hand, if it is determined at decision step 255 that the call has not ended, at decision step 260 it is determined if the caller has been, again, placed on-hold. For example, although the caller may have reached his or her intended party, that party may have to put caller back on hold while performing some service for the caller. Accordingly, if at decision step 260 it is determined that the caller has been placed on-hold once again, flow diagram 200 loops to step 235 to reconnect the selected audio at the point the audio was playing when the telephone line was taken off hold. Accordingly, until it is determined at decision step 255 that the call has ended, the line is continually monitored to determine if the caller has been placed on-hold so that the caller can be reconnected to the selected audio content.

While the preferred embodiment of the present invention has been illustrated and described, as noted above, many changes can be made without departing from the spirit and scope of the present invention. Accordingly, the scope of the present invention is not limited by the disclosure of the preferred embodiment.

What is claimed is:

1. A system for a caller, while placed on-hold, to selectively change media content provided on a telephone line, the system comprising: telephone switching software configured to engage the telephone line to determine when the caller is on hold; an available media generator configured to convey a list of media selections available to the caller on-hold; and a media choice selector configured to receive a media choice made by the caller on hold and cause selected media content to be presented to the telephone line such that it can be heard by a caller.
